(19) United States
(12) Patent Application Publication
(10) Pub. No.: US 2017/0174924 A1
(43) Pub. Date: Jun. 22, 2017

(54) Low VOC Universal High Performance Colorant

(71) Applicant: Valspar Sourcing, Inc., Minneapolis, MN (US)

(72) Inventors: Jacob Donlon, Prospect, KY (US); Mark Coward, Jeffersonville, IN (US)

(73) Assignee: Valspar Sourcing, Inc., Minneapolis, MN (US)

(21) Appl. No.: 15/454,227

(22) Filed: Mar. 9, 2017

Related U.S. Application Data
(63) Continuation of application No. PCT/US2015/049438, filed on Sep. 10, 2015.
(60) Provisional application No. 62/049,127, filed on Sep. 11, 2014.

(51) Int. Cl. C09D 17/00; C09D 7/12

(52) U.S. Cl. CPC C09D 17/001; C09D 7/1233

(57) ABSTRACT

A low VOC universal colorant composition for both solvent-based and water-based paints and coatings is provided. The composition includes a colorant component, a universal surfactant package; and a carrier. The colorant composition shows excellent stability with respect to viscosity, pH, and Hegman grind over time. The colorant composition is used to tint a base paint formulation which, after tinting, shows a desirable rheological profile and optimal block and tack resistance relative to base paints tinted using standard colorant lines.

### CROSS-REFERENCE TO RELATED APPLICATION(S)

This application is a continuation of International Application No. PCT/US2015/049438 filed 10 Sep. 2015, which claims priority from U.S. Provisional Application No. 62/049,127 filed 11 Sep. 11 2014, each of which is incorporated herein by reference in its entirety.

### BACKGROUND OF THE INVENTION

Pigments are used to impart color to both solvent- and water-based coating compositions or paints. They can also contribute opacity, durability and hardness to paint coatings. They are typically added to paint as dry pigment powders or as a tinting concentrate or colorant composition, either during paint manufacture in a plant, or at a point of sale, where the retailer adds a colorant composition to a white or tintable base paint formulation to obtain a custom colored paint as per a customer's choice.

For both consumer and industrial paints, whether solvent-based or water-based, the pigments must be homogenously dispersed throughout the paint. For proper dispersion, pigments are typically wetted in a vehicle by means of a surfactant. These surfactants are typically added to alkyd-based paints to ensure thorough pigment dispersion throughout the paint. Water-based systems are poor wetting agents for dry pigments, and therefore, latex paints require use of additional surfactants for pigment dispersion.

Surfactants can also be used to temporarily stabilize the pigment dispersion by preventing aggregation or reaggregation of pigment particles. However, conventional colorant compositions sometimes separate into their components over time and require periodic remixing. Some colorant compositions also adversely affect the rheological profile of the paint to which they are added. Moreover, many colorant compositions do not have low levels of volatile organic compounds (VOC) and are not universal, i.e. not compatible with both solvent- and water-based paints. Finally, many conventional colorants do not have the desired tinctorial strength to produce a wide range of custom colors, and do not necessarily demonstrate the desired mechanical properties for a dried film of the paint.

Therefore, there exists a need for colorant compositions that are stable (i.e. demonstrate little change in viscosity, pH, tinctorial strength, or Hegman grind over time), have low VOC, provide an advantageous rheological profile, and provide sufficient tinctorial strength and optimal mechanical characteristics to the paint film.

### SUMMARY

The present description provides a low VOC universal colorant composition that may be used with both solvent- and waterborne paints and coatings. The colorant compositions described herein provide particularly advantageous compatibility with both types of paint systems and demonstrate substantially high performance for finished paints made with the described colorants. The colorants described herein also provide finished paints with desirable rheological profiles and higher tinctorial strength than conventional colorants. The colorants described herein may be used to make paints with extremely low levels of VOC and allow for the accurate preparation of tinted paints via manual or auto-tinting dispense machines.

In one embodiment, the present description provides a low VOC colorant composition that includes an array of one or more colorant components including sufficient quantities of one or more pigments of a given hue, such that the coating composition can be made into a variety of custom colors not possible through mixing of standard pigments or colorants. The composition also includes a universal surfactant package compatible with latex-based and alkyd-based compositions and with compositions that include associative thickeners. In addition, the composition also includes a carrier. The colorant composition may include one or more optional additives.

In another embodiment, the present description provides a coating composition that includes an in-store tintable base paint formulation and about 0.05 to 15 wt % of a colorant composition. The colorant composition is added to the base paint at the point of sale to achieve a desired color, and contains less than 30 g/L VOC and less than 0.1 wt % alkyl phenol ethoxylate. The colorant composition further includes one or more colorant components, a universal surfactant package compatible with latex-based and alkyd-based compositions and with compositions that include associative thickeners, and a carrier. After tinting with the colorant composition, the base paint formulation has block resistance of at least 4 and tack resistance of less than about 60 seconds.

In yet another embodiment, the present description provides a method to obtain a paint formulation of a desired color. The method steps include providing a container with a quantity of an in-store tintable liquid base paint formulation and sufficient headspace to receive a quantity of at least one low VOC colorant composition, and dispensing the low VOC colorant composition into the base paint formulation at a point of sale and in a particular amount to give a paint formulation of a desired color. The colorant composition includes less than 30 g/L VOC and less than 0.1 wt % alkyl phenol ethoxylate. The colorant composition further includes one or more colorant components, a universal surfactant package compatible with latex-based and alkyd-based compositions and with compositions that include associative thickeners, and a carrier.

In an embodiment, a colored coating composition made from the method described herein is also disclosed. The method steps include providing a container with a quantity of an in-store tintable liquid base paint formulation and sufficient headspace to receive a quantity of at least one low VOC colorant composition, and dispensing the low VOC colorant composition described herein into the base paint formulation at a point of sale and in a particular amount to give a paint formulation of a desired color. In an aspect, the colorant composition does not cause tip drying when the colorant is dispensed.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### SELECTED DEFINITIONS

Unless otherwise specified, the following terms as used herein have the meanings as provided below.

The term “component” refers to any compound that includes a particular feature or structure. Examples of components include compounds, monomers, oligomers, polymers, and organic groups contained there.

The term “substantially free” of a particular compound means that the compositions described herein contain less than 0.5 wt % of the compound. The term “essentially free” of a particular compound means that the compositions of the present invention contain less than about 0.1% of the compound.

Unless otherwise indicated, a reference to a “(meth)acrylate” compound (where “meth” is bracketed) is meant to include both acrylate and methacrylate compounds.

The term “polycarboxylic acid” includes both polycarboxylic acids and anhydrides thereof.

The term “latex paint,” as used herein, refers to a water-based paint having a wide range of viscosity from a thin liquid to a semi-solid paste. The paint consists of a polymeric binder or resin dispersed in an aqueous carrier and a dispersion of one or more pigments, colorants, tinting agents, and/or metal effect agent, plus various additives commonly used in paints and coating compositions such as, for example, fillers and extenders. The terms “latex,” “water-based paint,” and “emulsion paint” are used interchangeably herein.

The term “solvent-based paint” refers to a uniformly-dispersed mixture having a wide range of viscosity from a thin liquid to a semi-solid paste. The paint consists of a resin or polymeric binder in an organic solvent carrier, pigment, colorant, tinting agent, and/or metal effect agent, along with other additives commonly used in paints and coating compositions, including extenders and fillers.

The term “volatile organic compound” (“VOC”), as defined by the Environmental Protection Agency (EPA) in 40 C.F.R. 51.100(s), refers to any compound of carbon, excluding carbon monoxide, carbon dioxide, carbonic acid, metallic carbides or carbonates, and ammonium carbonate, which participates in atmospheric photochemical reactions. Typically, volatile organic compounds have a vapor pressure equal to or greater than 0.1 mm Hg. As used herein, “volatile organic compound content” (“VOC content”) is as measured by ASTM D6886 (Standard method for determination of the weight percent of individual volatile organic compounds in waterborne air-dry coatings by gas chromatography) using methyl palmitate as the boiling point marker. The weight of VOC per volume of the coating solids, and is reported, for example, as grams VOC per liter (g/L).

As used herein, the term “low VOC” means the compositions described herein have less than about 30 g/L VOC. Unless otherwise indicated, the terms “low VOC” and “substantially free of VOC” are used interchangeably herein.

As used herein, the term “pigment” refers to an organic or inorganic material, and is typically (but not exclusively) in solid form. As used herein, the term “colorant” refers to a dispersion of pigment in a mobile phase, typically in liquid form, which is added to a coating composition to modify or alter its color or hue, typically at a point-of-sale. As the term is used herein, a colorant may include one or more pigments, dyes and/or inks, along with other additives.

The term “paint” or “coating” refers to a film applied as a thin layer to a substrate. The film may be clear or contain pigment, colorant, dye, tinting agent or metal effect agent. The paint may be opaque or transparent. The terms “paint” and “coating” are used interchangeably herein.

The term “base paint,” as used herein, means a composition that includes a vehicle component containing a binder or resin component, and a pigment or filler component dispersed into the vehicle component. As used herein, the base paint formulation includes water as the vehicle, a latex polymer as the binder or resin component, and one or more pigments or fillers used to tone or opacify the base paint as the pigment component.

The base paints described herein are “in-store tintable,” meaning that the base paints are present in containers (such as paint cans, for example) and can be tinted or colored by adding a colorant composition in the store, i.e. at a point of sale, to provide a paint formulation of a desired color and finish.

As used herein, the term “container” means any vessel (either with or without a lid or other type of closure) used to store, mix, tint or color a paint formulation, and includes the vessels in which paints are typically marketed and sold. Suitable containers include paint cans, paint bottles, containers made of metal, containers made of plastic and/or other polymeric materials, and the like.

The term “headspace” as used herein, refers to the volume remaining in a container after the container has been filled with a base paint.

As used herein, the term “block resistance” means the ability of a coating film or paint film, when applied to two surfaces, not to stick to itself on prolonged contact when pressure is applied for a defined period of time. It is a measure of the degree of hardness and/or degree of cure of a film of a coating composition or paint formulation, and is measured by a standard test method, ASTM D4946-89 (Standard Test Method for Blocking Resistance of Architectural Paints).

The term “tack resistance,” as used herein refers to the residual tack of a coating film or paint film after it has been applied to a substrate surface and dried. Tack resistance is typically measured by the Zapon tack test, as further described below.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one aspect, the present invention describes a universal colorant composition (e.g., for paints and coatings). In a particularly preferred embodiment, this invention relates to a universal colorant composition for coloring solvent- and water-based paints and coatings. The universal colorant composition accomplishes pigment dispersion in these dissimilar coating formulations through the use of a universal surfactant package, e.g., a surfactant package that includes at least one alkyd-compatible surfactant and at least one latex-compatible surfactant.

The colorant compositions described herein offer several advantages over conventional colorants, including the ability to use a single set of colorants for water-based and solvent-based paints or coatings. The colorant compositions described herein also demonstrate substantially better performance for block and tack resistance in finished paints or coatings. In addition, the colorant compositions described herein have higher tinctorial strength than conventional colorants, and can be used to make finished paints with extremely low levels of VOC. The colorants described herein do not cause tip-drying during manual or automatic dispensing, allowing for the more accurate preparation of tinted paints.

The colorant composition described herein is a low VOC composition and can be used to make a finished paint or coating with extremely low levels of VOC. The colorant compositions described herein preferably include less than about 30 g/L VOC, more preferably less than 20 g/L, and most preferably less than about 15 g/L VOC, as measured by ASTM D6886 (Standard method for determination of the weight percent of individual volatile organic compounds in waterborne air-dry coatings by gas chromatography) using methyl palmitate as the boiling point marker.

In an embodiment, the colorant compositions described herein include a universal surfactant package that includes at least one alkyd-compatible surfactant and at least one latex-compatible surfactant. The colorant compositions preferably include from about 1% to 20% by weight of the universal surfactant package. More preferably, the colorant compositions include from about 3% to 15% by weight of the universal surfactant package, and most preferably, the colorant compositions include from about 4% to 10% by weight of the universal surfactant package.

The colorant compositions described herein are generally compatible with and can be used for both alkyd and latex paints. Without limiting to theory, the colorants described herein are useful with both alkyd and latex paints, because the alkyd-compatible surfactant provides lipophilic properties and the latex-compatible surfactant provides hydrophilic properties. This allows the universal surfactant to disperse pigments in both organic carriers and aqueous carriers respectively.

In an embodiment, the colorant compositions described herein include a universal surfactant package that includes at least one latex-compatible surfactant and at least one alkyd-compatible surfactant. Examples of latex-compatible surfactants include, without limitation, polymers, copolymers and solutions thereof derived from ethylenically unsaturated monomers (e.g., styrene maleic anhydride copolymer solution (commercially available as SMA 1440H), maleic anhydride copolymer sodium salt (commercially available as Tamol 731A, structured acrylate copolymer), primary alcohol alkoxylates (e.g., alcohol ethoxylate, commercially available as Novel 23 E9 Ethoxylate and Novel 23 E7 Ethoxylate), secondary alcohol alkoxylates (e.g., secondary alcohol ethoxylate (commercially available as Tergitol 15-S-9), tridecyl alcohol ethoxylate (commercially available as Rhodasurf BC-720)), alkyl-substituted phenol alkoxylates (e.g., dodecyl phenol ethoxylate (commercially available as Rhodasurf BC-630)), aryl-substituted phenol alkoxylates (e.g., tristyryl phenol ethoxylate (commercially available as Soprophor TS-10)), unmodified polyalkoxylates, polymers with pigment affinic groups (e.g., copolymer solution with pigment affinic groups (commercially available as Tego Dispersant 750W), high molecular weight block copolymer with pigment affinic groups (commercially available as Disperbyk-190)), polyalkoxylates modified with neutral pigment affinic groups (e.g., commercially available as Disperbyk-2091), copolymers with acidic groups (e.g., commercially available as Disperbyk-102), block copolymers terminated with primary hydroxyl groups (e.g., difunctional block copolymers (commercially available as Hydropalat WE3167, WE 3317 and WE3135), tetrafunctional block copolymers (commercially available as Tetronic 904)), polyamine amide and polyesters (commercially available as Disperbyk-2095), nonionic surfactants (e.g., commercially available as Abex 2545), hydrophobic copolymer electrolytes (e.g., commercially available as Tamol 165A), and salts, mixtures or combinations thereof.

Examples of alkyd-compatible surfactants include, without limitation, lecithin (e.g., commercially available as Lecithin Soya Yelkin TS unbleached), dry lecithin (e.g., commercially available as Lecithin Oil Free Centrolex F Powder), alkyl amine salts of alkyl aryl sulfonate (e.g., isopropyl amine salt of alkyl aryl sulfonate (commercially available as G-3300 Alkyl Aryl Sulfonate), linear isopropylamine dodecylbenzene sulfonate (commercially available as Rhodacal IPAM)), polymers, copolymers or solutions thereof derived from unsaturated monomers (e.g., styrene maleic anhydride copolymer solution (commercially available as SMA 1440H)), linear alcohol alkoxy phosphate esters, branched alcohol alkoxy phosphate esters (e.g., commercially available as Rhodafac RS-710), secondary alcohol alkoxylates (e.g., secondary alcohol ethoxylate (commercially available as Tergitol 15-S-9)), unmodified polyalkoxylates, polyalkoxylates modified with neutral pigment affinic groups (e.g., commercially available as Disperbyk-2091), copolymers with acidic groups (e.g., commercially available as Disperbyk-102), polymers with primary hydroxyl functional, polyamine amide and polyesters (e.g., commercially available as Disperbyk-2095), and salts, mixtures or combinations thereof.

The universal surfactant package described herein will include at least one alkyd-compatible surfactant and at least one latex-compatible surfactant. A non-limiting example of a universal surfactant package includes a combination of lecithin, Tamol 731 and Tergitol 15-S-5, for example.

In an embodiment, the colorant compositions described herein are considered to be compatible with associative thickeners. By “compatible with associative thickeners” is meant that the addition of about 12 ounces of colorant to one gallon of a base paint formulation containing associative thickeners induces a viscosity drop in the paint of less than about 20 KU, preferably less than about 15 KU, more preferably less than about 10 KU. The viscosity is measured using conventional methods known in the art, including, for example, by use of a Brookfield KU-1+ Viscometer (Brookfield Engineering Laboratories, Middlesboro Mass.).

In one embodiment, the colorant compositions are substantially free of alkylphenol ethoxylate surfactants (APE). These surfactants are usually made from a branched chain nonylphenol or octylphenol, which is reacted with ethylene oxide. Substantially free of APE refers to compositions having less than 0.5% APE, preferably less than 0.1% APE.

In one embodiment, the colorant compositions are substantially free of lecithin and/or dry lecithin. Substantially free of lecithin refers to compositions having less than 15 wt % lecithin, preferably less than 10 wt % lecithin, more preferably less than 1 wt % lecithin.

In an embodiment, the colorant compositions described herein include a carrier. The carrier is used to disperse the pigment and the universal surfactant. In an aspect, the carrier is an organic component, such as an organic solvent. In another aspect, the carrier is an aqueous component. In a preferred aspect, the colorant compositions described herein include an aqueous carrier, preferably water. In an aspect, the colorant composition includes between 0 and about 75 wt % of the carrier.

In an embodiment, the colorant compositions described herein include one or more colorant components or an array of one or more colorant components. The colorant or array of colorants includes at least one pigment or dye, with pigments preferred over dyes for cost reasons. The actual amount of pigment or dye in a given colorant component varies depending on the desired hue and chosen pigment. In an aspect, the colorant composition described herein includes an array of one or more colorants that contain preferably about 5 wt % to 75 wt % pigment, more preferably 10 wt % to 60 wt % pigment, based on the total weight of the colorant composition.

Pigments for use in colorant components are known in the art. Suitable pigments include, for example, titanium dioxide white, carbon black, lampblack, black iron oxide, red iron oxide, transparent red oxide, yellow iron oxide, transparent yellow oxide, brown iron oxide (a blend of red and yellow oxide with black), umber, phthalocyanine green, phthalocyanine blue, organic reds (such as naphthol red, quinacridone red and toluidine red), DPP red, quinacridone magenta, quinacridone violet, carbazole violet, DNA orange, DPP orange, organic yellows (such as monoazo yellow), bismuth vanadate yellow, and mixtures or combinations thereof.

Accordingly, in an embodiment, when a base paint has to be tinted to provide paint having a particular color, the colorant component includes preferably at least about 5 wt %, more preferably 5 wt % to 30 wt %, most preferably 10 wt % to 50 wt % of the required pigment, based on the total weight of the composition. For example, when a base paint has to be tinted orange, the colorant component preferably includes 5 wt %, more preferably 10 wt % to 40 wt % DPP orange. Similarly, when a base paint has to be tinted yellow, the colorant component includes preferably at least about 5 wt % organic yellow, more preferably about 10 wt % to 50 wt % organic yellow. A base paint to be tinted green requires a colorant component including preferably at least 5 wt %, more preferably at least 5 wt % to 30 wt % phthalocyanine green. The type and amount of colorant can be selected and varied to obtain a wide range of custom paint colors.

The amount of pigment in a colorant component will be determined by the desired color for the base paint, the chosen hue and the chosen pigment. Accordingly, in an aspect, where significantly expanded color space, for example orange color space, is required, the array of one or more colorant components will include sufficient quantities of orange-hued pigments to provide custom colors not typically possible by combination of standard red and yellow pigments.

In an embodiment, the colorant compositions described herein optionally include additional components or additives. In an aspect, the colorant compositions described herein include one or more preservatives, humectants, biocides, fillers, defoamers, pH control agents, thickeners, anti-settling agents, and mixtures or combinations thereof. In an aspect, the colorant composition preferably includes a humectant. The humectant is selected from dihydric alcohol (e.g., ethylene glycol), polyhydric alcohol (e.g., propylene glycol), polyether, and the like. In a preferred aspect, the humectant is a polyether. Exemplary polyethers include, without limitation, polyalkyl glycols (e.g., low to moderate molecular weight polyethylene and polypropylene glycols), polyhydroxy ethers (e.g., those formed from epoxide polymerization), polysaccharide compounds (e.g., polysorbitan and polysorbital), polyalkylene oxides (e.g., polyethylene and polypropylene oxide), and mixtures and combinations thereof. In an aspect, the colorant compositions described herein include about 1 wt % to 20 wt % humectant, preferably about 2 wt % to 18 wt % humectant. Polyethers suitable for the compositions and methods described herein include linear ethylene glycol polyethers of low molecular weight, e.g., having a molecular weight of from 190 to 210 g and medium molecular weight polyethylene glycols, e.g., having molecular weight of from 285 to 315 g. Medium molecular weight polyethylene glycols are advantageous for use as vehicles because they are substantially free of very low molecular weight volatile organic solvents that are suspected toxins and/or teratogens.

Preferably, suitable ethylene glycol polyethers have an average molecular weight of from about 190 to about 800, more preferably from about 375 to 425, and most preferably from about 385 to 415. Particularly useful commercial polyethylene glycols are PEG 300 and PEG 400.

Another useful optional additive is a humectant such as, for example, the humectant GRB-2 from Zenica, which contains glycerin and a nonionic surfactant. Additional humectants which contains glycerin and a nonionic surfactant. Additional humectants useful in practicing the present invention include materials such as, for example, glycols such as ethylene glycol, propylene glycol, hexylene glycol, and the like; polyethylene glycols having molecular weights of about 300, 400, 500, and the like; polypropylene glycols having molecular weights of about 300, 400, 500, and the like; glycerin, sorbitol, sodium polyglutamate, modified urea compounds, polyethylene oxide and ethoxylated surfactants, and the like.

A defoaming agent may be added for ease of manufacture. Defoamers useful in practicing the present invention include materials such as, for example, mineral oil, silica oil (Drew L-474), organically modified silicone oils (Drew L-405), and the like.

A biocide may also be added to the colorant compositions of the present invention to eliminate or inhibit the growth of microorganisms. The biocide will generally account for between 0 and 1% by weight of the colorant composition. Biocidal chemicals include chlorinated hydrocarbons, organometallics, halogen-releasing compounds, metallic salts, organic sulfur compounds, quaternary ammonium compounds and phenolics. Useful commercial biocide examples are Troysan 192, Kathon LS, and the like.

A fungicide may also be added to the colorant compositions of the present invention to eliminate or inhibit the growth of microorganisms. Non-limiting examples of fungicides include compounds such as, for example, 3-Iodo-2-propynyl butyl carbamate (IPBC), chlorothalonil, Zinc Pyrithione, 2-N-octyl-4-isothiazalin-3-one, and the like. A preferred fungicide is IPBC.

Water may also be added to the colorant compositions of the present invention. Generally, water may make up between about 0 and 75% by weight of the colorant composition, depending on the particular colorant composition.

In another embodiment of the present invention, a colorant composition (e.g., a standard colorant or a colorant composition of the present invention) is provided in an easy to use container. Suitable cartridge-style containers for use with colorant compositions include “tubes,” “syringes,” and “caulking”-type cartridges. In a specific embodiment the colorant compositions can be provided in sealed pouches wherein the colorant composition can be readily dispensed in controlled amounts. These containers are preferred over traditional cans and jars. More preferably, the sealed pouches or containers have a nozzle or adapter orifice that facilitates clean entry of the composition into the tinting machine. In one embodiment the pouches are provided in boxes for ease of storage and use.

Suitable containers for use in the present invention include metal and plastic tubes (e.g., “toothpaste” style tubes), sealed plastic bags or pouches and caulking-tube cartridges (e.g., cartridges with plungers such as are described, for example, in U.S. Pat. Nos. 5,622,288; 5,560,521; and 5,297,697, which are herein incorporated by reference).

Methods to tint base paint formulations to provide paints with custom colors are described herein. In the methods described herein, a container with a quantity of a base paint formulation, preferably an in-store tintable base paint formulation, is provided, the container having sufficient headspace to receive a quantity of at least one low VOC colorant composition as described herein.

A variety of base paints and stains may be used in the disclosed system and method. For example, exemplary base paint sets may comprise, consist essentially of or consist of a set of white and clear (unpigmented) bases, or a set of white, midbase (intermediate white) and clear bases, or a set of white, pastel, standard color and clear bases. Colored base paints may optionally be included but preferably are not employed. The system may also optionally include one or more stain bases. For example, the system may include exterior or interior stains such as semi-transparent or solid color (viz., opaque) stains. By way of explanation it might be noted that when a semi-transparent stain is applied to wood, the wood grain and its texture normally remains noticeable, whereas when a solid color stain is applied the grain normally becomes hidden while the texture normally remains noticeable. When a paint is applied to wood, both the wood grain and its texture normally no longer are noticeable, and a new surface which completely hides the old surface and has its own appearance is presented. This new surface may be smooth or textured.

The base paints or stains typically will be packaged in containers suitable for small batch lots. Exemplary small batch lot container sizes are about one half pint, one pint, one quart, one liter, one gallon, four liter, five gallon or 20 liter containers, corresponding to containers from about 0.24 to 20 L. Depending on the amount of pigmentation (e.g., white pigmentation) already present in a base paint or stain, the container typically will have a small amount of headspace for colorant addition. For example, a one gallon (3.79 L) white base paint container may hold about 128 oz. (3.79 L) of the base paint, with only a small headspace volume available for colorant addition. A one gallon (3.79 L) clear base paint container may for example hold about 116 oz. (3.43 L) of the base paint, with about 12 oz. (0.35 L, or about 9% of the total container volume) of headspace available for colorant addition. When additional base paints of intermediate opacity are employed, they likewise may have intermediate available headspace volumes for colorant addition. For example, a four base system may employ the white and clear base paints mentioned above, together with a pastel base whose container has about 126 oz. (3.73 L) of base paint with about 2 oz. (0.06 L) of headspace available for colorant addition, and a standard color base whose container has about 124 oz. (3.57 L) of base paint with about 4 oz. (0.12 L) of headspace available for colorant addition.

The colorant compositions described herein may be dispensed manually or automatically, with automatic dispensation preferred. A variety of automated paint colorant dispensers may be used in the disclosed system and method, including the ACCUTINTER 1500, 2000, 7000 and 8000 series machines with a 1/384 fluid ounce (0.077 cm³) minimum dispensing quantity from Fluid Management, Inc., and the Sample Dispensing System with a 1/1024 fluid ounce (0.029 cm³) minimum dispensing quantity from Fluid Management, Inc. Additional automated paint colorant dispensers include the COROB MODULA HFmachine with a 1/192 fluid ounce (0.153 cm³) minimum dispensing quantity from CPS Color Equipment, Inc., and the TATOCOLOR machine with a 1/384 fluid ounce (0.077 cm³) minimum dispensing quantity from CPS Color Equipment, Inc. The chosen dispenser may for example have a minimum fluid dispensing quantity less than 0.01 fluid ounce (<0.3 cm³), preferably less than 0.007 fluid ounce (<0.2 cm³) and more preferably less than 0.005 fluid ounce (<0.15 cm³). Dispensers with even smaller minimum dispensing quantities may be employed, e.g. less than 0.001 fluid ounce (<0.03 cm³) or less than 0.0002 (<0.014 cm³) minimum dispensing quantities, but such dispensers may also require longer amounts of time to prepare strong colors in large containers. To overcome this, the dispenser may be modified to provide multiple dispensing circuits for one or more colorants, e.g., a lower flow rate, lower minimum dispensing quantity circuit and a higher flow rate, higher minimum dispensing quantity circuit for at least some (e.g., the green, blue, red and magenta if used) colorants in the dispenser. These circuits may share some common components (e.g., the withdrawal line from a colorant canister, the colorant dispensing nozzle or nozzles, or nozzle cleaning devices) and may employ some unshared components (e.g., gear pumps). The somewhat increased equipment cost necessitated by such an approach will be offset by an increased fill rate when making strong colors in large containers and by a reduced or eliminated need to use separate dispensers to handle larger or smaller colorant volumes.

In an aspect, in order to tint a base paint formulation to provide paint of a particular color, the colorant compositions are dispensed in an amount of preferably 0.01 wt % to 20 wt %, more preferably 0.05 wt % to 15 wt %. The amount of colorant dispensed will depend on the minimum dispensing quantity of the automated dispenser as well as on the desired color of paint and the chosen colorant.

A variety of colorants, including the colorant compositions described herein, may be employed in the methods disclosed herein. The compositions and methods described herein preferably employ an array of 8, 9, 10, 11 or 12 colorants, but may employ fewer colorants where a limited color space is acceptable, or more colorants if additional dispenser slots are available, and an expanded color space is required and/or acceptable.

In an embodiment, and without reference to the method of dispensing colorant (i.e. manual or automated), the colorant compositions described herein do not cause tip dry. By “tip dry” is meant the phenomenon whereby colorant dries out at the tip of the dispensing nozzle, resulting in reduction or complete loss of colorant flow through the dispensing nozzle during tinting. Therefore, because of tip drying, incorrect quantities of colorant are dispensed into the base paint, leading to improperly tinted paint. Surprisingly, the colorant compositions described herein do not cause tip drying when the colorant is dispensed, and therefore, the methods described herein allow for accurate preparation of tinted paints, whether the colorant is dispensed manually or using an automated dispensing system. When an automatic dispensing system is used, the colorant compositions described herein do not cause tip dry, as long as appropriate procedures are followed after the colorants are dispensed, including cleaning, purging, capping, covering, recirculating, and agitating the automated dispensing system.

In an embodiment, the colorant compositions described herein are substantially uniform and require little mixing prior to use. In an aspect, the colorant compositions described herein require up to about 3 minutes of mechanical shaking prior to use, but preferably no shaking is required at all, even after extended shelf life.

In an embodiment, the colorant compositions described herein have extended shelf life. By “extended shelf life” is meant that the compositions do not show significant change in viscosity, pH, Hegman grind, or alkyd- and latex-compatibility over time. The compositions are tested for extended shelf life stability by heating a sample of the colorant at 140° F. (60° C.) for six weeks. After the heating period, the colorant composition is evaluated for changes in viscosity, pH, Hegman grind, or alkyd- and latex-compatibility. A composition is considered stable if, after the heating period, the composition shows a viscosity increase of less than about 50 KU, preferably less than about 10 KU. More preferably, the compositions will have a viscosity increase of less than about 5 KU.

A colorant composition is considered to have extended shelf-life or be stable if, after the heating period, the composition shows a pH change of less than about 50%, more preferably, a pH change of less than 25%. Similarly, a colorant composition is considered to be stable if, after the heating period, the composition shows less than a 50% change in Hegman grind, preferably a change of less than 25%.

The extended shelf life or stability of the colorant compositions described herein may also be assessed by subjecting the colorant compositions to multiple freeze-thaw cycles, after which the colorant compositions would be examined for changes in viscosity, pH, Hegman grind, or alkyd- and latex-compatibility. For testing, a sample of the colorant composition is frozen and thawed for at least three cycles, after which the colorant is examined for changes in viscosity, pH, Hegman grind, or alkyd- and latex-compatibility. A colorant composition is considered to be stable if, after at least three freeze-thaw cycles, the composition shows viscosity change of less than about 50 KU, preferably less than 15 KU, more preferably less than 10 KU.

A colorant composition is considered to be stable or have extended shelf life if, after at least three freeze thaw cycles, the composition demonstrates less than 50% change in pH, preferably less than 25% change in pH. Similarly, a colorant composition is considered to be stable if, after at least three freeze thaw cycles, the composition shows less than a 50% change in Hegman grind, preferably a change of less than 25%.

Conventionally, when a colorant composition is added to base paint formulation to obtain a colored paint, the viscosity of the base paint is reduced. This reduction in viscosity affects the properties of the finished paint. For example, a paint with low viscosity is difficult to apply, may not provide the necessary hide or coverage, and may not have the required block or tack resistance. Moreover, as base paints are made to have low or no VOC by using softer polymers or binder resins, and low or no VOC-containing colorants added to the base paint also have a high percentage of non-volatile soft components, it is difficult to form a hard film or coating that has good mechanical characteristics, i.e. block resistance, and tack resistance, for example.

Surprisingly, however, the colorant compositions described herein do not significantly reduce the viscosity of the base paint after tinting. In an aspect, the reduction or drop in viscosity on addition of the colorant composition is less than 50 KU. In another aspect, the drop in viscosity is less than 25 KU. In yet another aspect, the drop in viscosity is less than about 10 KU.

The colorant compositions described herein, contrary to expectation, do not impact the mechanical properties of the base paint formulation after tinting. Accordingly, in an embodiment, the tinted base paints formed from the colorant compositions described herein provide excellent block and tack resistance. In an aspect, the base paint formulation, after tinting with the colorant composition, has block resistance of more than about 4 and tack resistance of less than about 60 seconds, more preferably block resistance of more than about 6 and tack resistance of less than about 30 seconds, and most preferably block resistance of more than about 8 and tack resistance of less than about 10 seconds.

Conventionally, to obtain certain types of colored paint, a high colorant load is required, and amounts of colorant and pigment selection must be adjusted to obtain desired color strength. This leads to an increase in paint cost and the addition of large amounts of colorant may have a negative impact on certain mechanical properties of the paint. However, the colorant compositions described herein have higher tinctorial strength than standard machine-dispensed colorant lines. Consequently, it is possible to use much lower quantities of colorants to obtain a paint with comparable color strength using the colorant compositions described herein, and no negative impact on the mechanical properties of the paint is seen.

For example, a standard yellow colorant has about 40% the tint strength of a yellow colorant as described herein. Similarly, a standard medium yellow colorant has about 85% of the tint strength of a medium yellow colorant as described herein, and a standard magenta colorant has about 50% of the tint strength of the magenta colorant described herein. Without limiting to theory, the color or tinctorial strength of the colorant corresponds to the amount of prime pigment in the colorant composition. In an aspect, the colorant compositions described herein have higher tinctorial strength because the colorants include a higher amount of prime pigment relative to conventional or standard colorants.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available.

### TEST METHODS

Unless indicated otherwise, the following test methods were utilized in the Examples that follow.

### Block Resistance

The block resistance of the paint formulations is tested using ASTM D4946-89 (Standard Test Method for Blocking Resistance of Architectural Paints).

### Tack Resistance

Tack resistance of the paint formulations is measured by the Zapon tack test. An aluminum lever of 3″ (7.62 cm) in length and 1″ (2.54 cm) wide is bent at a 40° angle from the vertical, creating a 1″ (2.54 cm) platform and 2″ (5.08 cm) lever. A drawdown is made using 4 mil (0.10 mm) Bird bar and allowed to cure overnight. The Zapon tack tester is then set on the film and weighted with a specific weight and allowed to stand for a specific period of time (i.e. a 1000 g weight for 30 seconds). Upon removal of the weight, the time taken for the Zapon tack tester to fall over is observed and recorded. A film that has no tack will cause the tack tester to fall over instantly.

### EXAMPLES

In the Examples 1-2 below, colorant compositions as described herein were made. Specifically, pigments were dispersed into a vehicle containing water, a universal surfactant package, defoaming agent, biocide, fungicide, humectant and extender fillers or pigment pastes.

### Example 1

TABLE 1
Preparation of Colorant Compositions
Magenta

| Ingredient | Parts (by weight) |
|---|---|
| Water | 873.85 |
| Humectant | 116.85 |
| Defoamer | 23.46 |
| Soprophor TS-10 | 31.80 |
| Rhodafac RS-710 | 76.80 |
| Tamol 165A | 31.20 |
| Rhodacal IPAM | 30.00 |
| Magenta Pigment | 429.03 |
| Biocide # 1 | 11.51 |
| Biocide # 2 | 2.77 |
| Biocide # 3 | 1.28 |
| Fungicide | 4.69 |
| Extender Paste # 1 | 1000.00 |
| Extender Paste # 2 | 366.76 |

### Example 2

TABLE 2
Preparation of Colorant Compositions
Orange

| Ingredient | Parts (by weight) |
|---|---|
| Water | 931.91 |
| Humectant | 103.76 |
| Defoamer | 7.51 |
| Amine | 30.00 |
| Soprophor TS-10 | 15.00 |
| Rhodafac RS-710 | 33.00 |
| Tamol 165A | 14.10 |
| Abex 2545 | 21.90 |
| Rhodacal IPAM | 8.70 |
| Orange Pigment | 730.86 |
| Extender Pigment | 477.83 |
| Biocide # 1 | 10.70 |
| Biocide # 2 | 2.84 |
| Biocide # 3 | 1.37 |
| Fungicide | 5.58 |
| Extender Paste # 1 | 345.63 |
| Extender Paste # 2 | 245.74 |
| Shader Paste # 1 | 35.27 |
| Shader Paste # 2 | 8.31 |

### Example 3

The orange and magenta colorants were prepared as described in Examples 1 and 2 and then assessed for initial stability as well as stability after heating to 140° F. (60° C.) for different time points of one week, three weeks and six weeks. Results are shown in Table 3.

TABLE 3
Stability of Colorant Composition

| | Time | Viscosity | Grind | pH |
|---|---|---|---|---|
| Orange | Initial | 60 | 7 | 9.0 |
| colorant | 1 week | 60 | 7.5 | 8.8 |
| | 3 weeks | 60 | 7.5 | 8.7 |
| | 6 weeks | 61 | 7 | 8.7 |
| Magenta | Initial | 59 | 7 | 7.7 |
| colorant | 1 week | 60 | 7.5 | 7.9 |
| | 3 weeks | 61 | 7+ | 7.7 |
| | 6 weeks | 60 | 7 | 7.7 |

### Example 4

The orange and magenta colorants in Examples 1 and 2 were used to tint a base paint formulation, and the tinted paint was then assessed for initial viscosity as well as changes in viscosity overnight. The tinted base paints were compared to base paints tinted with standard colorants and with an untinted base paint. Results are shown in Table 4.

TABLE 4
Overnight Viscosity of Tinted Paint

| | Initial Stormer | Overnight Stormer |
|---|---|---|
| Sample | Viscosity (KU) | Viscosity (KU) |
| Untinted base paint | 121 | 123 |
| Standard Orange | 111 | 113 |
| Standard Magenta | 114 | 115 |
| Orange | 115 | 116 |
| Magenta | 116 | 116 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A universal colorant composition, comprising
one or more of a colorant component containing less than 30 g/L VOC and less than about 0.1 wt % alkylphenol ethoxylate surfactants;
a universal surfactant package compatible with latex-based and alkyd-based compositions and with compositions that include associative thickeners;
a carrier; and
optionally, at least one additive selected from preservatives, humectants, dispersants, extender fillers, defoamers, pH control agents, thickeners, anti-settling agents, and combinations thereof,
wherein the colorant composition comprises an array of colorant components containing sufficient quantities pigment of a particular hue to provide custom colors not possible using standard colorants.

2. A coating composition, comprising:
an in-store tintable liquid base paint formulation; and
about 0.05 to 15 wt % of one or more colorant compositions added to the base paint formulation at a point-of-sale to achieve a desired color, the one or more colorant compositions comprising one or more of a colorant component containing less than 30 g/L VOC and less than about 0.1 wt % alkylphenol ethoxylate surfactants;
a universal surfactant package compatible with latex-based and alkyd-based compositions and with compositions that include associative thickeners;
a carrier; and
optionally, at least one additive selected from preservatives, humectants, dispersants, extender fillers, defoamers, pH control agents, thickeners, anti-settling agents, and combinations thereof,
wherein the base paint formulation, after tinting, has block resistance of at least 4 and tack resistance of less than about 60 seconds.

3. The composition of claim 1, wherein the colorant component is selected from organic pigments, inorganic pigments, colorants, dyes, tinting agents, metal effect agents, and mixtures or combinations thereof.

4. The composition of claim 1, wherein the colorant component is a pigment selected from titanium dioxide white, carbon black, lamp black, black iron oxide, red iron oxide, transparent red iron oxide, yellow iron oxide, transparent yellow iron oxide, brown iron oxide, umber, phthalocyanine green, phthalocyanine blue, naphthol red, DPP red, quinacridone red, quinacridone magenta, quinacridone violet, carbazole violet, DNA orange, DPP orange, organic yellows, bismuth vanadate yellow, and mixtures or combinations thereof.

5. The composition of claim 1, wherein the universal surfactant package comprises at least one surfactant compatible with a water-based composition and at least one surfactant compatible with a solvent-based composition.

6. The composition of claim 1, wherein the universal surfactant package comprises at least one surfactant compatible with a latex-based composition and at least one surfactant compatible with an alkyd-based composition.

7. The composition of claim 1, wherein the universal surfactant package is about 1 to 20 wt % of the total weight of the colorant composition.

8. The composition of claim 1, wherein the latex-compatible surfactant is selected from polymers, copolymers and salts thereof derived from one or more ethylenically unsaturated monomers, polymers, copolymers and salts thereof derived from primary alcohol alkoxylates, polymers, copolymers and salts thereof derived from secondary alcohol alkoxylates, polymers, copolymers and salts thereof derived from alkyl-substituted phenol alkoxylates, polymers, copolymers and salts thereof derived from aryl-substituted phenol alkoxylates, unmodified polyalkoxylates, polyalkoxylates modified with pigment affinic groups, polymers, copolymers and salts thereof with pigment affinic groups, polymers, copolymers and salts thereof with acidic functionality, polymers, copolymers and salts thereof with primary hydroxyl functionality, polyamine amide and salts thereof, polyesters and salts thereof, and combinations thereof.

9. The composition of claim 1, wherein the alkyd-compatible surfactant is selected from lecithin, alkyl aryl sulfonate salts of isopropyl amine, dry lecithin, polymers, copolymers and salts thereof derived from one or more ethylenically unsaturated monomers, branched alcohol ethoxy phosphate ester, polymers, copolymers and salts thereof derived from primary alcohol alkoxylates, polymers, copolymers and salts thereof derived from secondary alcohol alkoxylates, polymers, copolymers and salts thereof derived from alkyl-substituted phenol alkoxylates, polymers, copolymers and salts thereof derived from aryl-substituted phenol alkoxylates, unmodified polyalkoxylates, polyalkoxylates modified with pigment affinic groups, polymers, copolymers and salts thereof with pigment affinic groups, polymers polyamine amide and salts thereof, polyesters and salts thereof, linear isopropylamine dodecylbenzene sulfonate, and combinations thereof.

10. The composition of claim 1, wherein the carrier is aqueous.

11. The composition of claim 1, wherein the carrier is water.

12. The composition of claim 1, wherein the colorant composition contains a humectant.

13. The composition of claim 1, wherein the humectant is a dihydric or polyhydric alcohol.

14. The composition of claim 1, wherein the humectant is a polyether.

15. The composition of claim 1, wherein the polyether includes a polyalkyl glycol, polyhydroxyether, polysaccharide, modified polyurea, or polyalkylene oxide.

16. The composition of claim 1, wherein the polyether includes a polyethylene glycol or polypropylene glycol and has a molecular weight between about 100 and 2500.

17. The composition of claim 1, wherein the polyether is PEG 400.

18. The composition of claim 1, wherein the colorant composition requires 3 minute mechanical shaking prior to use.

19. The composition of claim 1, wherein the colorant composition comprises an array of colorants that contain between 5 wt % and 75 wt % pigment.
